(19) United States
(12) Patent Application Publication
(10) Pub. No.: US 2006/0144920 A1
(43) Pub. Date: Jul. 6, 2006

(54) Identifiable reading tag, commercial system and portable device applying identifiable reading tag

(76) Inventors: Chien-Hsing Fang, Hsinchu City (TW); Leeway Yen, Qionglin Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/132,379

(22) Filed: May 19, 2005

Related U.S. Application Data
(60) Provisional application No. 60/638,404, filed on Dec. 27, 2004.

(30) Foreign Application Priority Data
Feb. 5, 2005 (CN) 2005100072250

(51) Int. Cl. G06F 17/00; G06F 17/30; G08B 13/14

(52) U.S. Cl. 235/375; 340/572.1; 707/1

(57) ABSTRACT

A commercial system with identifiable reading tags to get useful data is provided. A participation entity, such as a business store, company, non-profit organization, or person, etc., applies registration to a system provider, or the system provider actively provides to create a plurality of identifiable reading tags with unified specification protocol which are fixed on participation entities, such as at least one store, street intersection, public facility, transportation, public used advertisement or product, business card. Every identifiable reading tag has a special label and at least one content tag object capable of representing content data of corresponding participation entities. The data, i.e. corresponding participation entities, content data, and identifiable reading tags, etc., will be integrated into a system database thereby not only benefits to compensate the positioning function with other communication positioning systems but also convenient for users to get a useful data in real time.

### FIELD OF THE INVENTION

The present invention is related to a commercial system, and more particularly to a commercial system with identifiable reading tags for getting useful data, not only GPS systems or communication base station systems can be paired up, but also it is convenient for users to get useful data in real time.

### BACKGROUND

Currently, the common identifiable tags can be seen in each business locations, such as VISA, MASTER credit card special labels which can be seen everywhere worldwide. The customers can clearly identify and understand that the business locations are special stores, which can accept credit cards according to the special labels. However, except this, the special labels cannot provide other functions, and the customers cannot further get information of each location or entity. Therefore, the best effect of the special labels cannot be brought into exercise.

Further, by the development of mobile wireless network, by WLAN system which is usually used such as in NB (notebook), PDA (personal digital assistant) or WAP (wireless application protocol) system by which GPRS cell phones and CDMA cell phones go online, users can browse a lot of information or search network data on portable devices. The browsing and searching way is the same as the wired connection. It is not convenient for using small portable devices and quite time-consuming and expensive.

Nowadays there are cell phone system providers providing positioning locations of cell phones with their telecommunication base stations and then providing users to get information service of each locations of located areas. However, such positioning ways, take an example of GSM systems, are generally in a range of several kilometers, but the locations provided by system providers are hundreds in this range. It is not accurate enough. Therefore, users still have to spend time to search data as needed. Besides, the data is collected and provided by the system providers in one way, so the data is not necessary needed by users and not complete.

Further, for WAP functions with which cell phones go online, the content is almost provided by telecommunication providers and cooperative vendors, so the content is limited or individual web pages have to be searched and linked. Therefore, the incentive attracts users to go online to browse WAP, which is not enough. This is the reason why WAP is not popular now. It also affects promoting 3G-wideband mobile networks in the future.

Further, tag systems of general products, for example, bar code systems or RFID (radio frequency identification) systems, mainly fix a product barcode or a RFID tag on a product to easy to control and sell products. Also, there are vendors offer an application concept of fixing the RFID tag on an object in a fixed location outside of the products and using portable RFID reading devices to read data therein. However, the data, which can be saved in the RFID tags is limited. Even corresponding databases or web sites linked according to RFID tag information are always built up individually. No unified system database to be provided for users to access. Of course, other positioning systems cannot be paired up to use, and the positioning functions cannot be compensated and useful data cannot be got in real time.

Further, currently, GPS (global positioning system) mainly pairs up with geography information system (GIS) to construct map information for navigation and positioning. GPS positioning navigation map system can provide road system, main geographic buildings, and famous business locations on the map information but cannot provide most entire location information on the system. Besides, GPS still has limitations. At bad satellite signal places, such as indoor or metropolitan, the positioning function can also be invalid, and the original function is lost.

### SUMMARY OF THE INVENTION

Accordingly, how to design a novel identifiable reading tag and commercial system and portable device applying identifiable reading tags is the key point of the present invention. The shortcomings of previous systems can be efficiently avoided, the users are provided to get useful data in a direct and quick case, and commercial activities can be promoted.

It is a primary object of the present invention to provide a commercial system applying identifiable reading tags. By users of participation entities applying registrations or system providers actively providing, a plurality of identifiable reading tags and a system database are created. Besides, the identifiable reading tags can be fixed on the corresponding participation entities. Thereby, not only it is convenient for users to get useful data in a direct and quick case, but also working time and cost is saved.

It is a secondary object of the present invention to provide a commercial system applying identifiable reading tags. By unifying specification protocols of identifiable reading tags, it is convenient for users to quickly link to system database or object database. The trouble and difficulty of searching data on portable devices by users can be avoided.

It is another object of the present invention to provide a commercial system applying identifiable reading tags. It is advantageous to develop entire community, promote commercial activities, introduce products or exhibits, have guide function, or avoid users of portable devices from getting lost.

It is another object of the present invention to provide a commercial system applying identifiable reading tags. By distributing identification tags with unified standard specification in a big amount, other positioning systems can be paired up to use, such as GPS or telecommunication base stations. Thereby, the positioning problem caused by other positioning systems in metropolitan or bad satellite signal places can be compensated at the place where tags set to achieve an accurate positioning function.

It is another object of the present invention to provide an identifiable reading tag. At least one content tag object and a special label are fixed on the identifiable reading tag. Thereby, not only it is convenient for users to identify to decide whether to view content data in the identifiable reading tag, but also various tag reading methods are provided to prevent from unable keeping using identifiable reading tags because single content tag object is invalid.

It is another object of the present invention to provide a portable device. At least one tag reader is fixed therein to choose reading or downloading content represented by identifiable reading tags. Thereby, the use range of the portable device can be extended.

Therefore, to achieve the previous mentioned objects, the present invention provides an identifiable reading tag. A plurality of content tag objects are set on an identifiable reading tag. Tag data can be existed in the content tag object. The tag data can be read by a portable device. Thereby, one of label data and a connection to a link database shown on the portable device can be selected.

Further, to achieve the previous mentioned objects, the present invention provides a commercial system applying identifiable reading tags. It mainly comprises: at least one identifiable reading tag having at least one content tag object thereon, and a tag data capable of existing in the content tag object; at least one participation entity on each of which the identifiable reading tag can be fixed; a system database capable of providing relative link relationship between tag data of each identifiable reading tag and the participation entities and thereby connecting to at least one link database; and a portable device in which at least one tag reading module and a content presentation element are set, the tag data in the identifiable reading tag can be read by the tag reading module, and a tag data to present on the content presentation element or a connection to a link database thereby can be chosen.

Further, to achieve the previous mentioned objects, the present invention provides a portable device applying an identifiable reading tag. It mainly comprises at least one tag reading module and at least one content presentation element, the tag reading module can read tag data in an identifiable reading tag and select one of presenting the tag data on the content presenting element and connecting to a link database thereby.

### BRIEF DESCRIPTION OF DRAWINGS

FIG. 1 is a structure diagram of a preferred embodiment of an identifiable reading tag of the present invention.

FIG. 2 is a structure diagram of a preferred embodiment of a portable device of the present invention.

FIG. 3 is a flow chart of creating a system database of the commercial system of the present invention.

FIG. 4 is a flow chart of pairing up with GPS positioning system to create GPS data of the commercial system of the present invention.

FIG. 5 is a use diagram of a preferred embodiment of the commercial system of the present invention, using the portable device to get useful data.

FIG. 6 is a use diagram of a preferred embodiment of the commercial system of the present invention.

FIG. 7 is a flow chart of the commercial system of the preferred embodiment of the present invention in use as shown in FIG. 6.

### DETAILED DESCRIPTION

The structural features and the effects to be achieved may further be understood and appreciated by reference to the presently preferred embodiments together with the detailed description.

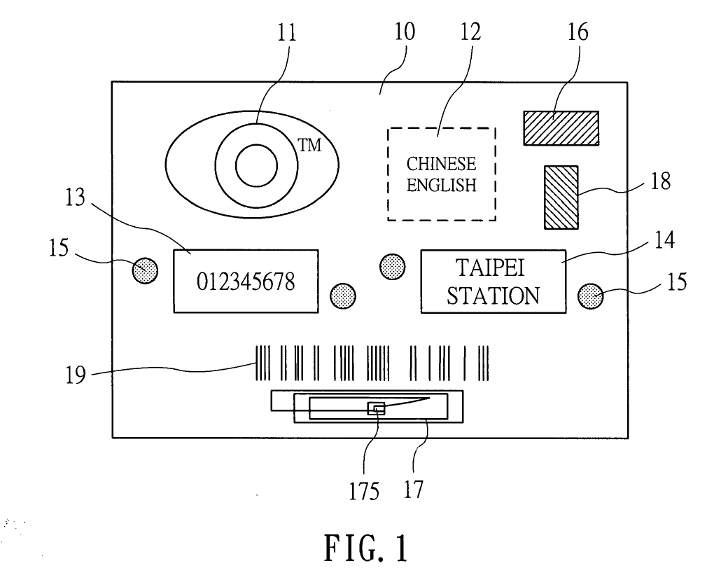

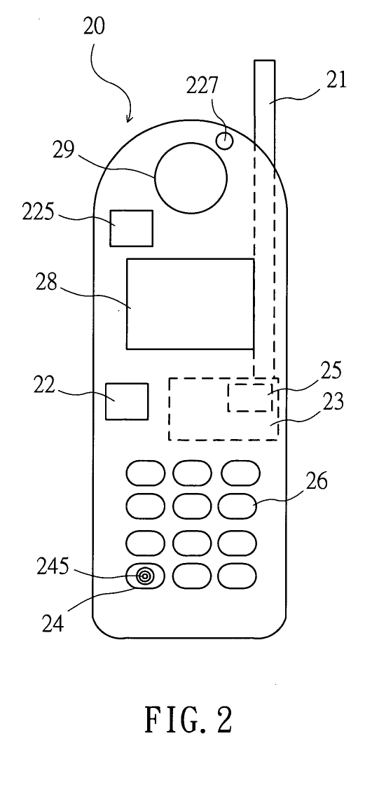

Firstly, referring to FIG. 1, a structure diagram of a preferred embodiment of an identifiable reading tag of the present invention. As shown, the identifiable reading tag 10 can has a special label 11 for customers to easy to know that this identifiable reading tag 10 is added into the commercial system of the present invention. If using the portable device (20), as shown in FIG. 2, useful data (as detailed described as below) can be read or downloaded with the identifiable reading tag 10.

The identifiable reading tag 10 can further has a content tag object representing the identifiable reading tag 10, such as visual code, for example, number code 13 or name code 14. The users of the portable device (20) can represent that they want to read data in the identifiable reading tag 10 by pushing the number keys (26) after inputting the visual code 13/14. The name code 14 can selectively be at least one letter, symbol, number, or a combination thereof.

The content tag object on the identifiable reading tag 10 can also be a radio-frequency identification tag (RFID tag) 17 or a barcode tag 19. The barcode tag 19, as barcode of products, can generate input signals representing number code 13 or name code 14. The RFID tag 17 has a RFID chip for storing tag data 175 of preliminary data related to the identifiable reading tag 10, such as location name, web address, product manufacturer name, address, telephone number, longitude and latitude coordinate of location, neighboring map, or a combination thereof. Besides, the RFID tag 17 can selectively be a passive RFID tag without power supply or an active RFID tag with power supply. If the RFID tag 17 is selected as an active RFID tag, the identifiable reading tag 10 has a feature of having power supply, so the identifiable reading tag 10 can also has an audio generating device 16 or a infrared emitting module 18 to generate audio output or infrared signal output representing number code 13, name code 14, tag data 175, or barcode tag 19 for the portable device (20) to read data.

Further, in another embodiment of the present invention, the identifiable reading tag 10 further has at least one alignment symbol 15 to aid the portable device (20) to read alignment datum point of the visual code 13/14 with the image capturing module (22).

The identifiable reading tag 10 further has a language marking area 12. A word or mark of Chinese, English, German, Japanese, or other languages can be marked thereon to tell customers that the system database saved by the identifiable reading tag 10 or to be linked uses which language to be the main communicating tool.

According to having unified specification protocol, the identifiable reading tag 10 of the present invention needs at least one external participation entity, such as business store, company, non-profit organization, or person, to apply registration to a system provider, or the system provider provide and make actively. Therefore, it is benefit to create sequential system database. Besides, it has various input interfaces providing users to use. Therefore, it is suitable in various locations and various portable devices (20) for customers to easy to use.

Furthermore, refer to FIG. 2, a structure diagram of a preferred embodiment of a portable device of the present invention. As shown, the portable device 20 of the present invention can selectively be a cell phone, personal digital assistant (PDA), notebook (NB), hand-held or vehicle global positioning system (GPS) device, digital camera, MP3, MP4 video/audio player, voice player, recording pen, etc. As illustrated in the embodiment, it is a cell phone 20.

The portable device 20 at least has a radio-frequency signal processor 23 for processing a wireless radio-frequency signal, a content presentation element, such as a display module (e.g. monitor) 28 or an audio module 29 (e.g. speaker or microphone), a radio-frequency antenna 21 for transmitting wireless radio-frequency signals, and a plurality of number keys 26.

The portable device 20 can also has an RFID reading module 25 fixed in the radio-frequency signal processor 23 or on the radio-frequency antenna 21. In the previous embodiment, it can interact with its RFID tag (17) in the active range of the identifiable reading tag (10) and read the content data of the tag data (175).

The portable device 20 can also has an image capturing module (such as digital camera module) 225 or an infrared receiving module 227 for receiving image signals presented by the visual code (13/14) from the identifiable reading tag (10) or infrared signals outputted by the infrared emitting module (18) as needed. Of course, the audio module 29 of the portable device 20 can also receive audio signals outputted from the audio generating device (16) of the identifiable reading tag (10). The image signals, infrared signals, audio signals or the visual code (13/14) data input by number keys 26 all can represent tag data (175) in the identifiable reading tag (10) to be read by the portable device 20 by various input interfaces.

Further, in another embodiment of the present invention, the portable device 20 can further has a GPS module 22. Not only use the GPS system to achieve the function of positioning, but also convert the longitude and latitude data to useful data with the system database as described below of the present invention when using the GPS system to get longitude and latitude data of the location.

Further, in another embodiment of the present invention, the portable device 20 can further has a link system hot key 24. The link system hot key 24 can has a special label 245. The link system hot key 24 can be set as an active key of the previous input interface module 22/225/25/29/227 to link to the entry web page of the commercial system or the system database to easy to get useful data.

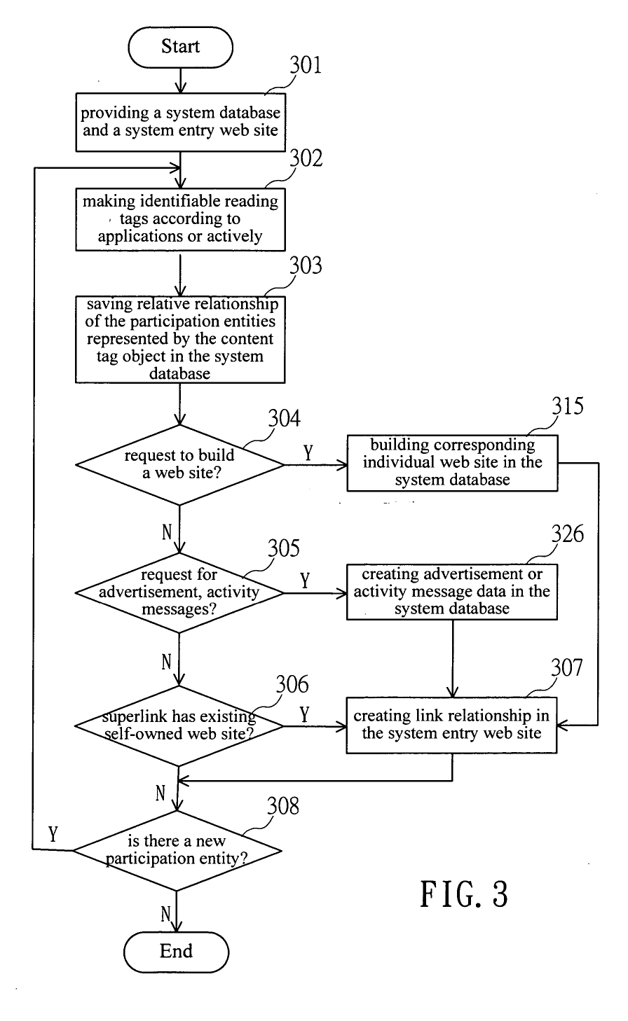

Next, please refer to FIG. 3, a flow chart of creating a system database of the commercial system of the present invention. As shown, the commercial system of the present invention can integrate a plurality of identifiable reading tags with unified specification protocol into a system database or a system entry web site providing useful data. The creating flow steps are:

Step 301: a system provider provides a system database and a system entry web site.

Step 302: the system provider accepts at least one external participation entity, such as business store, company, non-profit organization, or person to apply registration, or the system provider actively provide and make a plurality of identifiable reading tags with unified specification protocol. These identifiable reading tags will be set on participation entities, such as stores, street intersection fixtures, public facilities, transportation, public advertisement, business cards, or products.

Step 303: the system provider create the content tag object of every identifiable reading tag, such as visual code, RFID tag, barcode tag, audio generating device, infrared emitting module, or a combination thereof, and corresponding relationship of tag data (basic data), preliminary data, or detailed data existed with the identifiable reading tag in the system database.

Step 304: query whether the registered participation entity has the need of creating individual web site? If yes, then perform step 315; if not, then continue to perform step 305.

Step 315: the system provider aids to create individual web sites of the registered participation entities in the system database. Besides, continue to perform step 307.

Step 305: query whether the registered participation entity has the need of creating advertisement, activity messages, preliminary data, or detailed data? If yes, then perform step 326; if not, then continue to perform step 306.

Step 326: the system provider aids to create advertisement, activity messages, preliminary data, or detailed data of the registered participation entities in the system database. Besides, continue to perform step 307.

Step 306: query whether the registered participation entity wants to super-link to existed self-owned web site? If yes, then perform step 307; if not, then perform step 308.

Step 307: the system provider saves the corresponding link relationship of the created individual web site, advertisement, activity messages, preliminary data, detailed data, or super-link to existed self-owned web site in the system database and present in the entry web site. Besides, continue to perform step 308.

Step 308: continue to detect whether new participation entities add in? If yes, then continue to perform step 302; if not, then complete creating the system database and the system entry web site and finish.

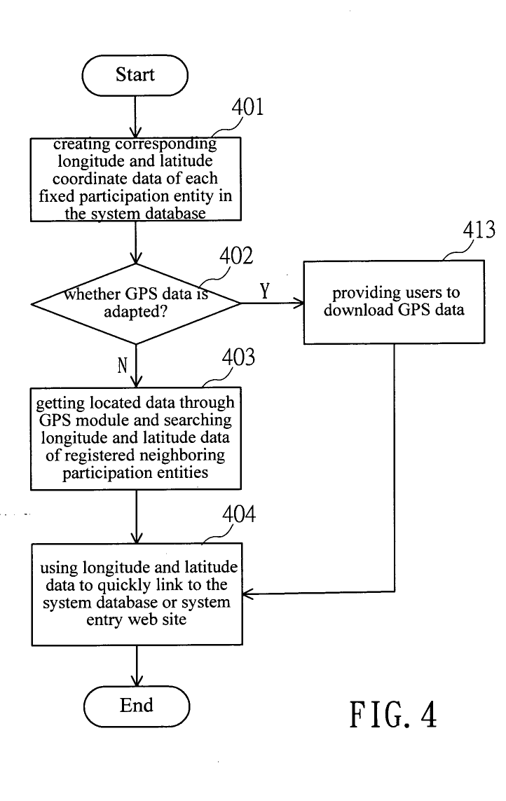

In addition, please refer to FIG. 4, a flow chart of application relationship of the system database of the commercial system of the present invention pairing up with GPS positioning system. As shown, the system database and the system entry web site created as in previous embodiment of the present invention can pair up with other positioning systems, such as GPS global positioning system or telecommunication base station system. The application relationship is shown as following steps:

Step 401: the system provider create corresponding link relationships and GPS data with respect to longitude and latitude coordinate data corresponding to the location of every registered fixed participation entity and the content tag object or tag data of the identifiable reading tag and save them in the system database and the system entry web site. The GPS data can authorize the GPS map system provider to use and users of the portable devices to download.

Step 402: detect whether the GPS module in the portable device wants to use and download GPS data in the system database? If yes, perform step 413; if not, then continue to perform step 403.

Step 413: provide the portable device to download GPS data in the system database. Besides, continue to perform step 404.

Step 403: the portable device knows present location through the GPS module and search longitude and latitude data of registered fixed participation entities according to this. Besides, continue to perform step 404.

Step 404: the portable device users link to the system entry web site or the system database by known longitude and latitude data of fixed participation entities and decide whether to download tag data, advertisement, activity messages, preliminary data, detailed data, etc. of the fixed participation entities. Of course, individual web sites or self-owned web sites can be directly connected to according to longitude and latitude data. In other words, longitude and latitude data of each location is directly converted to its web address for portable devices to quickly link.

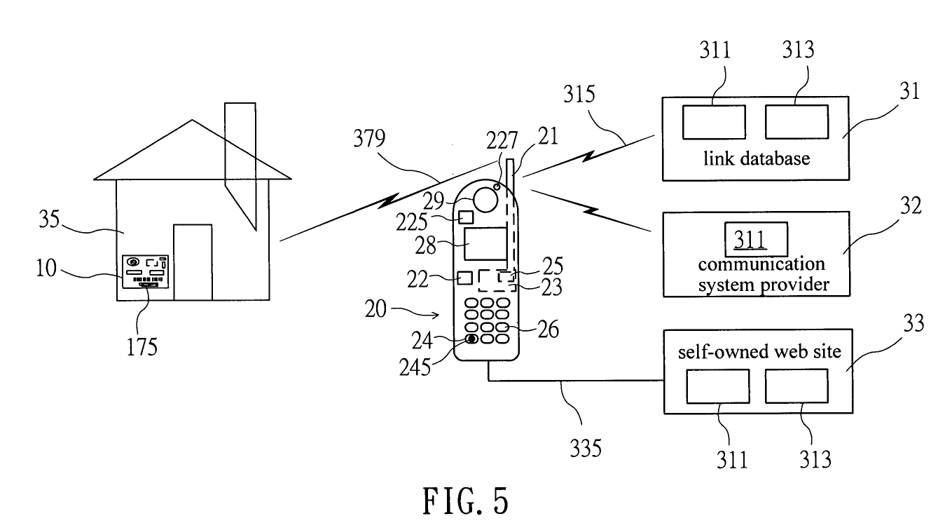

Further, please refer to FIG. 5, a use diagram of a preferred embodiment of the commercial system of the present invention, using the portable device to get useful data. As shown, when the user of the portable device 20 is close to a registered participation entity (such as a store) 35, since the store 35 has an identifiable reading tag 10, and the tag 10 is printed with a visual code 13/14 representing the store 35, the user can input the visual code 13/14 by number keys 26 and link to the system entry web site or the system database 31 to get information related to the store 35, such as preliminary data 311 or detailed data 313, by a wired or wireless connection 315. The preliminary data 311 or detailed data 313 can selectively be a peripheral environment data, sale product data, activity message data, bargain products, special store, identify registration, store, location name, manufacturer name, address, telephone number, web address, longitude and latitude coordinate, identification code, sale product category, price, store data, or a combination thereof related to the store 35.

Further, if the portable device 20 has a tag reading module 25/225/227, the content tag object 16/17/18/19 on the identifiable reading tag 10 of the store can be directly read by an identification signal 379 in an active range, the tag data 175 in the identifiable reading tag 10 can be directly read, or the preliminary data 311 or detailed data 313 is got by a connection 315 to link the system database or the system entry web site 31. Besides, whether to show on the content presentation element 28/29 can be chosen. For example, display the content of the tag data 175 on the display module or play the content of the tag data 175 in the voice module 29 for blind people to use. Since the commercial system of the present invention is distributed unified standard identifiable reading tag 10 in the location of each participation entity in a great number, the blind people can be provided guide function as well.

Further, the tag data (basic data) 175 saved in the identifiable reading tag 10 can selectively be a store name, address, telephone number, web address, longitude and latitude coordination, or identification code representing previous data. When the tag reading module 25/225/227 of the portable device 20 reads the web address or identification code representing the store 35, the portable device 20 can connect to a link database through a wireless connection 315 or a wired connection 335 or a database pre-downloaded in the portable device, such as a network server (e.g. system database or system entry web site) 31, a communication system provider 32, or a self-owned web site 33. The system database 31, communication system provider 32, or self-owned web site 33 can pre-save the preliminary data 311 or detailed data 313 related to the product 35, select whether to download such preliminary data 311 or detailed data 313 to the portable device 20, or select whether to show in the content presentation element 28/29.

Further, in another embodiment of the present invention, when the portable device 20 connects to the self-owned web site 33 related to the store 35, it naturally becomes an entry end of identity registration. For example, directly register to become a member in the self-owned web site 33 or register the lottery. This way, it is advantageous to promote the commercial actives.

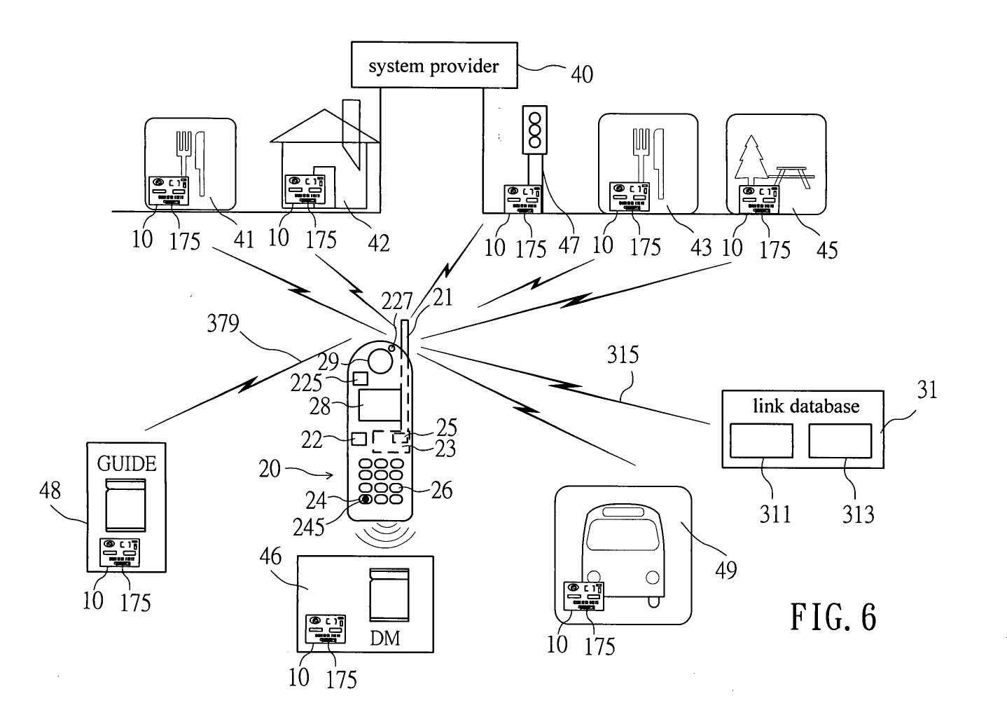

Next, please refer to FIG. 6, a use diagram of a preferred embodiment of the commercial system of the present invention. As shown, the present invention mainly uses a system provider 40 to accept application registration of business stores, companies, government organizations, non-profit organizations, or people, or the system provider 40 actively provides to make a corresponding identifiable reading tag 10 with unified specification protocol. Low cost readable tags 10 will be fixed in at least one participation entity, such as public locations 45 of stores 41, 42, 43, gas stations, stations, parks, street intersection fixtures/public facilities 47 of bus stops, traffic lights, lamps, guideboards, transportation 49 of buses, public boats, public advertisement, business cards 46, or products 48 in a great number. Corresponding identifiable reading tags 10 on every participation entity 41-49 all have a special label 11 thereby the customers can easily identify whether the entities participate into the commercial system of the present invention. The identifiable reading tag 10 can further has a tag data 175 for saving the basic data content of the store for saving store name, address, telephone number, web address, longitude and latitude coordinate, or identification code representing previous data.

When the user of a portable device 20 hands the portable device 20, goes on the road or close to any participation entity 41-49, and selects activating the tag reading module 25, the tag data 175 of the participation entities 41-49 to be read is quickly and conveniently shown on the content presentation element 28/29 of the portable device 20 by the identification signals 379.

Further, when the tag data 175 has a web address, longitude and latitude coordinate, or identification code which is read by the tag reading module 25, a connection database 31 can be connected through wired or wireless connection 315, such as a system database, a system entry web site, a communication provider, or a self-owned web site. The connection database 31 can save preliminary data 311 or detailed data 313 related to the participation entities 41-49.

In this embodiment, the preliminary data 311 or detailed data 313 can comprise peripheral environment data representing map, public facility location, emergency telephone number, or stop station near the participation entities or comprise sale product data or activity message data as shown in previous embodiment. Of course, store name, manufacturer name, address, telephone number, web address, or identification code can also be included. This way, when the user of the portable device 20 goes to a strange environment, the readable tags 175 near participation entities 41-49 can be used, without being in a panic or helpless situation. This way, it is advantageous to the commercial activities of products or whole community.

Further, in another embodiment of the present invention, when the portable device 20 with RFID reading function held by a lost person or lost is passed by the participation entities 41-49, the tag data 175 of the participation entities 41-49 passed by will be read periodically because the portable device 20 is preset, the real location can be quickly adjusted further according to the communication record linking to the database 31 periodically. The user or the portable can be searched according to this data, so many social problems can be reduced.

Further, in another embodiment of the present invention, when the user of a portable device 20 or other people want to call to emergency aiding units, such as police stations, fire stations, or hospitals, in a strange environment because of emergency accidents, the participation location code is input into neighboring participation entities 41-49 or the tag reading module is paired up with its emergency phone numbers, the location to be helped will be informed the emergency aiding units thereby grasping gold time of aiding.

The previous searching and emergency positioning functions can create a unified database to provide such help because the commercial system of the present invention distributes low-cost unified standard identifiable reading tag 10 in a great number in various locations. Therefore, the creation of such a unified database will become a resource benefit to the society to provide to the police and fire stations.

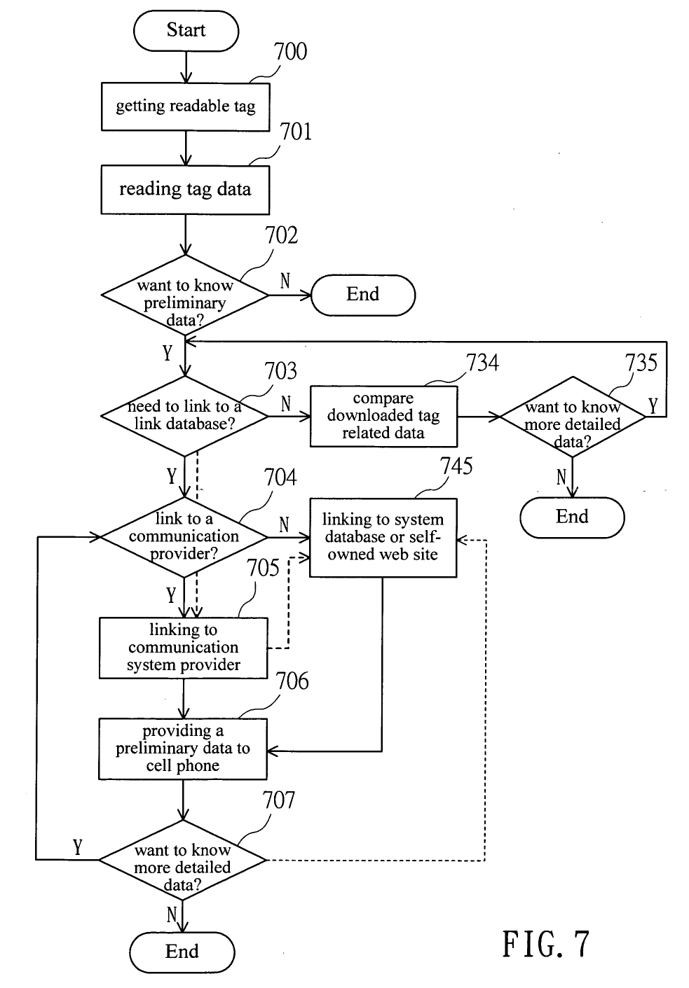

In addition, please refer to FIG. 7, a typical flow chart of a preferred embodiment of the commercial system of the present invention. Please refer to FIG. 6 as well. The method of the commercial system of the present invention for users to use comprises the following steps:

Step 700: a corresponding identifiable reading tag 10 is fixed on each participation entity 41-49 by applying registration by the owners of the participation entities 41-49 or by actively providing by the system provider 40.

Step 701: when the user carries a portable device 20 and wants to know the participation entity information represented by an identifiable reading tag 10, he can go close to one of the participation entities 41-49, such as store 41, or visually get visual code 13/14 on the identifiable reading tag 10. The tag data 175 signals outputted by other content tag objects 16/17/18/19 by pushing number keys 26 or receiving wirelessly. Besides, whether to show the tag data 175 of the store 41 in the content presentation element 28/29 of the portable device 20 can also be chosen. Alternatively, directly continue to perform step 702.

Step 702: after viewing the tag data 175, the user of the portable device 20 will decide whether to know the preliminary data 311 or detailed data 313 related to the store 41. If not, then end the reading action. If yes, then perform step 703.

Step 703:. whether the portable device 20 has read a web address or identification code content related to the store 41? Besides, decide whether to connect to a connection database 31/32/33. If not, then perform step 734. If yes, then perform step 704.

Step 704: The portable device 20 connects to a communication system provider through a wired or wireless connection 315 automatically or by the indication of the user. If yes, perform step 705. If not, then perform step 745.

Step 705: indicate to directly connect to a communication system provider 32. The preliminary data 311 provided by the communication system provider 32 will save a plurality of member web sites or self-owned web site data of the participation entities.

Of course, in another embodiment of the present invention, the web address content in the tag data 175 is set as directly connecting to the system database, the system entry web site 31, or self-owned web site 33. It can also be set that decide whether to connect to the self-owned web site 33 through the system entry web site 31, as marked by dotted line. This way, not only the content making flow of the tag data 175 can be simplified, but also the object of safety is achieved.

Step 745: indicates to directly connect to a self-owned web site 33 or the system database/system entry web site 31 according to the content of the read tag data 175. Besides, continue to perform step 706.

Step 706: the user will decide whether to download preliminary data 311 or detailed data 313 from the system database 31, communication system provider 32, or self-owned web site 33. If yes, then download the preliminary data 311 or detailed data 313 into the portable device 20 and show the downloaded content in the content presentation element 28/29.

Step 707: the user of the portable device will decide whether to continue downloading more detailed data 313. If yes, then repeat step 704 or step 745 to step 706. If not, then end this reading action.

Further, Step 734: indicate that the portable device 20 has downloaded preliminary data 311 or detailed data 313 corresponding to the tag data 175. Therefore, the portable device 20 will compare downloaded preliminary data 311 or detailed data 313 according to the tag data 175 and show in the content representation element 28/29 of the portable device 20.

This use is very suitable for exhibition, museum, or sport occasions. For example, when seeing a famous picture, the exhibition may provide data of the author, but the introduction of picture background or other pictures of the same author cannot be understood in a short time. At this time, after comparing the tag code of the exhibition, more detailed preliminary data 311 or detailed data 313 can be known quickly and accurately by using the present invention. Besides, by the voice module 29 playing the content voice, it is advantageous for blind people or special occasions.

Step 735: the user will decide whether to continue downloading more detailed data 313. If yes, then repeat step 703. If not, then end this reading action.

Further, before departing, the traveler can pre-download the data of the participation entities of the area to be gone with wired network connection. When arriving that area, the tag code of the participation entity can be compared with the previous way to correspondingly get location data in pre-downloaded data. This is especially useful for going to the countries with different telecommunication systems. This way, the user only needs to have a portable device 20 with enough memory, content display interface, and user interface, such as MP3, MP4, and hand-held GPS devices. The system database 31 is not necessary to be wirelessly connected in real time. Besides, the information provided by the system database 31 can also be used. Currently, the space of the built-in or extended memory card in cell phone or PDA is bigger and bigger. It is quite convenient to pre-download data into the built-in or extended memory card. Further, the built-in digital camera in cell phone or PDA is more and more popular. After using the digital camera to capture the image of the identifiable reading tags, after processing by image software, an object of inputting tag information can be achieved. The manual input can be avoided.

Similarly, for the travelers coming from other countries, the Tourism Bureau or tourism vendors can widely set identifiable reading tags 10 at each popular spots according to the commercial system and create complete and plentiful travel information in various languages in the system database 31 for travelers to download and use. It is benefit to develop the tourist business.

Finally, please refer to FIG. 4 and FIG. 6 at the same time. Since the present invention can use the system provider 40 to make a great number of identifiable reading tags 10 with unified specification protocol and widely distribute in fixed participation entities, such as stores 41/42/43, public facilities or public locations 45, street intersection fixtures 47. Besides, every identifiable reading tag 10 can set related map data near the fixed participation entities 41/42/43/45/47 in its tag 175, preliminary data 311, or detailed data 313. Therefore, the commercial system of the present invention can pair up to use with other positioning systems, such as GPS or telecommunication base stations.

For example, when the user of the portable device 20 is out of the active range of the identifiable reading tag 10 and cannot know whether there are participation entities 41/42/43/45/47 nearby visually, the GPS map data with big range of located place can be got by the action of the GPS module 22 on the portable device 20. The GPS map data is provides by the GPS system provider. The GPS map data can be compared with the GPS data provided by the commercial system of the present invention to search whether there exist registered participation entities in this range. If yes, then use the portable device to connect to the system database 31 or the self-owned web site 33 of the participation entity thereby quickly and accurately knowing registered participation entity data and peripheral environment information to be used.

In the contrary, when the user of the portable device 20 is in the active range of the identifiable reading tag 10 and the GPS module 22 is invalid (or without a GPS function), after getting the tag data 175 by the input interface of the portable device 20, the database is connected to get the real accurate position of the user of the portable device 20 and the peripheral detailed map data thereby reducing the risk of getting lost. It is very suitable in metropolitan.

Similarly, the commercial system and system database 31 of the present invention can also cooperate with each communication system provider 32. The telecommunication base stations (not shown) of each communication system provider 32 are used to ensure the location of a big range of the user of the portable device 20. Then search whether exist the participation entities of the present invention in this area. This way, the real accurate position of the user of the portable device 20 can also be quickly and accurately known. Besides, the detailed map data can be used.

In summary, the present invention relates to a commercial system, and more particularly to a commercial system using identifiable reading tags to get useful data. Not only GPS system or communication base station system can be paired up to use two different positioning ways to get information of the system database. But also it is good to compensate the positioning function through the system tag data or system database. Besides, it is convenient for users to get useful data in real time. Therefore, the present invention should be granted a patent.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

10 identifiable reading tag

11 special label

12 language marking area

13 number code

14 name code

15 alignment symbol

16 audio generating device

17 RFID tag

175 tag data

18 infrared emitting module

19 barcode tag

20 portable device

21 radio-frequency antenna

22 GPS module

225 image capturing module

227 infrared receiving module

23 radio-frequency signal processor

24 link system hot key

245 special label

25 tag reading module

26 number key

28 display module

29 audio module

31 system database

311 preliminary data

313 detailed data

315 link connection

32 communication system provider

33 self-owned web site

335 link connection

35 store

40 system provider

41 store

42 store

43 store

45 street intersection fixture

47 public location

46 product advertisement

48 product specification

49 public transportation

1. An identifiable reading tag, the improvement comprising:
a plurality of content tag objects in an identifiable reading tag, a tag data existing in said content tag objects, and said tag data capable of being read by a portable device thereby one of said tag data and a connection to a link database presenting on said portable device can be chosen.

2. The identifiable reading tag according to claim 1, wherein said content tag objects can be selected from a number code, a name code, a barcode tag, a RFID tag, an audio generating device, an infrared emitting module and a combination thereof, and said tag data can be selected from a location name, a web address, a product manufacturer name, an address, a telephone number, longitude and latitude coordinate of a location, a neighboring map, and a combination thereof.

3. The identifiable reading tag according to claim 1, wherein said identifiable reading tag further selectively has one of a special label, a language marking area, an alignment symbol, and a combination thereof.

4. A commercial system applying an identifiable reading tag, comprising:
at least one identifiable reading tag having at least one content tag object thereon, and a tag data capable of existing in said content tag object; at least one participation entity on each of which said identifiable reading tag being fixed;
a system database capable of providing relative link relationship between tag data of each identifiable reading tag and said participation entities and thereby connecting to at least one link database; and
a portable device in which at least one tag reading module and a content presentation element are set, said tag data in said identifiable reading tag can be read by said tag reading module, and a tag data to present on said content presentation element or a connection to a link database thereby can be chosen.

5. The commercial system according to claim 4, further comprising a system provider which can actively accept application registration of at least one external participation entity to make said identifiable reading tag such that said identifiable reading tags all have a uniform specification protocol.

6. The commercial system according to claim 4, wherein said participation entities can be selected from a store, a public location, a public facility, a fixture on said street, transportation, a product, a product specification, advertisement, business card, and a combination thereof.

7. The commercial system according to claim 4, wherein said content tag objects can be selected from a number code, a name code, a barcode tag, a RFID tag, an audio generating device, an infrared emitting module and a combination thereof, and said tag data can be selected from a location name, a web address, a product manufacturer name, an address, a telephone number, longitude and latitude coordinate of a location, a neighboring map, and a combination thereof.

8. The commercial system according to claim 4, wherein said identifiable reading tag further selectively has one of a special label, a language marking area, an alignment symbol, and a combination thereof.

9. The commercial system according to claim 4, wherein said link database can be selected from a system database, a system entry web site, a communication system provider, a self-owned web site, and a combination thereof.

10. The commercial system according to claim 4, wherein said portable device can further comprises an image capturing module, an infrared receiving module, an audio module, a RFID reading module, a plurality of number keys and a combination thereof to receive said tag data existing in said content tag object.

11. The commercial system according to claim 5, wherein said system provider accepts said application of said participation entities and helps to make at least one individual web site, advertisement, activity message, and a combination thereof in said system entry web site.

12. The commercial system according to claim 4, wherein said portable device further comprises a GPS module for generating longitude and latitude coordinate for receiving GPS data in said system database through said link database and searching information of pre-existed at least one participation entity, said portable device can receive and build-in a GPS map data first and get accurate positioning information by said tag data on said participation entities corresponding to said GPS map data, and said GPS map data can be selectively provided by one of a GPS system provider and a communication system provider.

13. The commercial system according to claim 4, wherein said portable device selectively has one of a wired connection and a wireless connection to connect to said link database and select to download one of said tag data, preliminary data, detailed data, and a combination thereof related to said participation entities, and said preliminary data and detailed data can selectively be peripheral environment data, sale product data, activity message data, bargain products, special stores, identity registration, stores, location names, manufacturer names, addresses, telephone numbers, web addresses, longitude and latitude coordinates, identification codes, sale product categories, prices, store data, and a combination thereof.

14. The commercial system according to claim 4, wherein said portable device can selectively be a cell phone, PDA, NB, GPS, digital camera, voice player, video/audio player, recording pen, and a combination thereof.

15. The commercial system according to claim 4, wherein said tag data, preliminary data, and detailed data of said participation entities can be saved in said portable device prior to said portable device reading said identifiable tag.

16. The commercial system according to claim 12, wherein the longitude and latitude coordinate of a location of each participation entity can be saved in said identifiable reading tag, said system entry web site, said system database, and said link database by activating said GPS module to get said longitude and latitude coordinate of said location to link to corresponding ones.

17. A portable device applying an identifiable reading tag, comprising
at least one tag reading module and at least one content presentation element, said tag reading module can selectively be an image capturing module, an infrared receiving module, an audio module, a RFID reading module, and a combination thereof to read said tag data in an identifiable reading tag and select one of presenting said tag data on said content presenting element and connecting to a link database thereby.

18. The portable device according to claim 17, further comprising a plurality of number keys, a special label, a GPS module, and a combination thereof wherein at least one number key is set as a link system hot key, and said GPS module can selectively receive data provided by a GPS system provider, a system provider, and a combination thereof.
